(19) United States
(12) Patent Application Publication
(10) Pub. No.: US 2024/0028577 A1
(43) Pub. Date: Jan. 25, 2024

(54) HARDWARE ACCELERATED STRING FILTER

(71) Applicant: Intel Corporation, Santa Clara, CA (US)

(72) Inventors: Jixing Gu, Shanghai (CN); Vinodh Gopal, Westborough, MA (US); Fang Xie, Santa Clara, CA (US); David Cohen, Hull, MA (US); Wajdi Feghali, Boston, MA (US)

(73) Assignee: Intel Corporation, Santa Clara, CA (US)

(21) Appl. No.: 18/225,939

(22) Filed: Jul. 25, 2023

(30) Foreign Application Priority Data
Jun. 13, 2023 (WO) PCT/CN2023/099944

(51) Int. Cl. G06F 16/22

(52) U.S. Cl. CPC G06F 16/2272; G06F 16/24568

(57) ABSTRACT

An apparatus may include an accelerator and a processor. The processor may receive an input string targeting a data buffer comprising a plurality of strings. The processor may receive, from the accelerator, a fixed-length data buffer based on the data buffer, respective ones of a plurality of entries of the fixed-length data buffer based on respective ones of the strings. The processor may receive, from the accelerator, a plurality of streams, respective ones of the plurality of streams to comprise a portion of respective entries in the fixed-length data buffer. The processor may generate, based on the input string, a plurality of target portions of the input string. The processor may receive, from the accelerator, indexes of the plurality of streams based on respective target portions of the input string matching respective entries of the plurality of streams. The processor may aggregate the indexes received from the accelerator.

### CROSS-REFERENCE TO RELATED APPLICATIONS

This application claims the benefit of and priority to previously filed International Application No. PCT/CN2023/099944 entitled “HARDWARE ACCELERATED STRING FILTER” filed Jun. 13, 2023, which is hereby incorporated by reference in its entirety.

### BACKGROUND

Modern computing devices may include general-purpose processor cores as well as a variety of hardware accelerators for performing specialized tasks. Certain computing devices may include one or more accelerators, which may include resources that may be configured by the end user or system integrator.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2A illustrates a block diagram of a computing device for database acceleration in accordance with at least one embodiment; and

FIG. 2B illustrates a block diagram of a computing system for database acceleration in accordance with at least one embodiment.

FIG. 3 illustrates an aspect of the subject matter in accordance with one embodiment.

FIG. 4 illustrates an aspect of the subject matter in accordance with one embodiment.

FIG. 5 illustrates a method 500 in accordance with one embodiment.

FIG. 6 illustrates an aspect of the subject matter in accordance with one embodiment.

### DETAILED DESCRIPTION

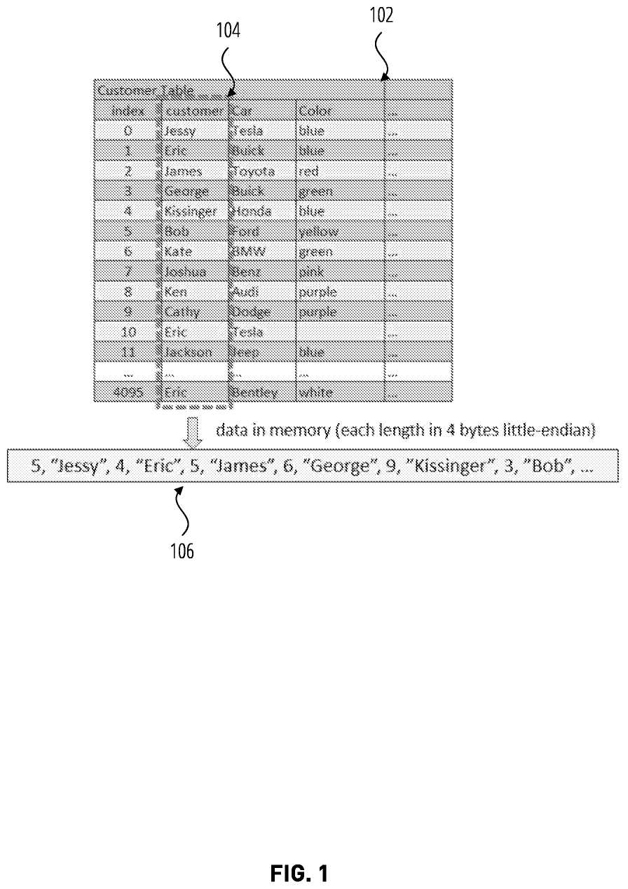

Embodiments disclosed herein provide technical solutions to address technical challenges regarding data stores such as analytics databases and data warehouses, particularly related to columnar data format widely used in analytics databases. The technical solutions described herein improve efficiency and performance to reduce system bottlenecks. FIG. 1 illustrates an example database table 102, which may be stored in a memory device, such as volatile or non-volatile memory device. The depicted example shows the table 102 using a “plain” encoding in a parquet file; however, embodiments described herein are not limited to the specific format shown here. Further, while a portion of the table 102 is depicted, the table size is not limited to what is shown. The table 102 can include hundreds of Terabytes of data with a multitude of rows (e.g., 100s of millions). Further yet, the illustrated table 102 includes a table with columns index, customer, car, color, etc., however, other embodiments can include different, additional, or fewer, columns. Technical challenges with accessing data from the table 102 include the use of columnar filters, such as string filters.

Several data storage techniques use column-oriented data storage. For example, Apache Parquet is a column-oriented data file format designed for efficient data storage and retrieval. It provides efficient data compression and encoding schemes with enhanced performance to handle complex data in bulk. Apache Parquet is designed to be a common interchange format for both batch and interactive workloads. It is similar to other columnar-storage file formats available in Hadoop®, namely RCFile and ORC. Columnar storage like Apache Parquet is designed to bring efficiency compared to row-based files like comma separated values (CSV). Columnar data storage has helped reduce storage requirements by at least one-third on datasets, in addition, also improved scan and deserialization time, hence the overall costs. However, as described herein, when operating filters such as string-based filters on one or more columns in such data, bottlenecks can arise. The embodiments described herein are rooted in computing technology, such as the columnar data storage systems and facilitate improving efficiency of such systems.

FIG. 1 depicts query-results 106 of an example database query SELECT <column-x>FROM <table>WHERE “customer”=“Eric”) that uses a string filter on a column 104 of the table 102. The current solutions include leveraging central processing unit (CPU) to scan the data from the table 102 to locate target record indexes while executing query clause like “SELECT <column-x>FROM <table>WHERE “customer”=“Eric”. The string column filter operator consumes a large number of processing cycles (CPU cycles) to filter out record indexes from the table 102. Such string column filters are required to execute queries on databases, such as SQL clauses. Technical challenges or disadvantages of existing solutions include, one, the heavy consumption of CPU cycles; and two, throughput of the query execution is constrained by the CPU performance/frequency. A cause of such technical challenges can be attributed to the variable-length strings that are included in the column 104 that sit side by side in memory, making it challenging to filter the variable length strings efficiently.

Embodiments described herein address such technical challenges by leveraging in-memory analytics acceleration (IAA) to accelerate the string column filter operations. The in-memory acceleration facilitates improved efficiency for several operations like scan, select, expand, run length encoding (RLE) etc. However, in some hardware, such IAA features only work on integer data types (and not for string operations). The embodiments described herein further overcome such limitations by splitting and redefining the flow to compute the string operations cooperatively between CPU and IAA module (e.g., hardware).

Embodiments disclosed herein address technical challenges rooted in computing technology, particularly string-based column filtering in tables of data. More particularly, embodiments described herein address technical challenges when performing string-based column filtering in tables of data using in-memory analytics acceleration that operates on integer data types. Embodiments described herein offload CPU cycles, thereby freeing these CPU cycles for executing other workloads which improves system efficiency. Additionally, embodiments described herein improve filter throughput by using the IAA specific operations, such as expand, scan, select, RLE, etc., which may be provided by certain hardware architectures (e.g., CPUs).

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the Figures and the accompanying description, the designations “a” and “b” and “c” (and similar designators) are intended to be variables representing any positive integer. Thus, for example, if an implementation sets a value for a=5, then a complete set of components 121 illustrated as components 121-1 through 121-a may include components 121-1, 121-2, 121-3, 121-4, and 121-5. The embodiments are not limited in this context.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, the given logic flow may be implemented by a hardware element, a software element executed by a processor, or any combination thereof. The embodiments are not limited in this context.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

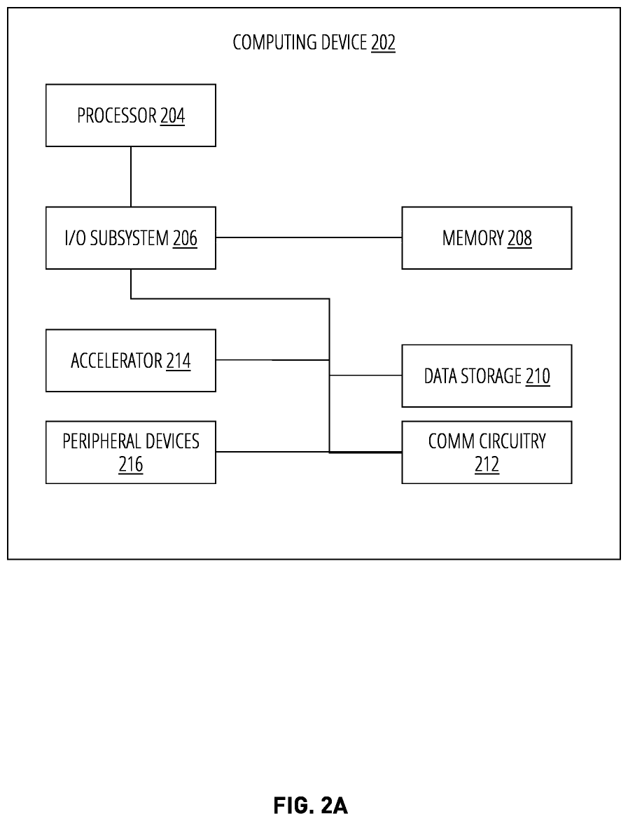

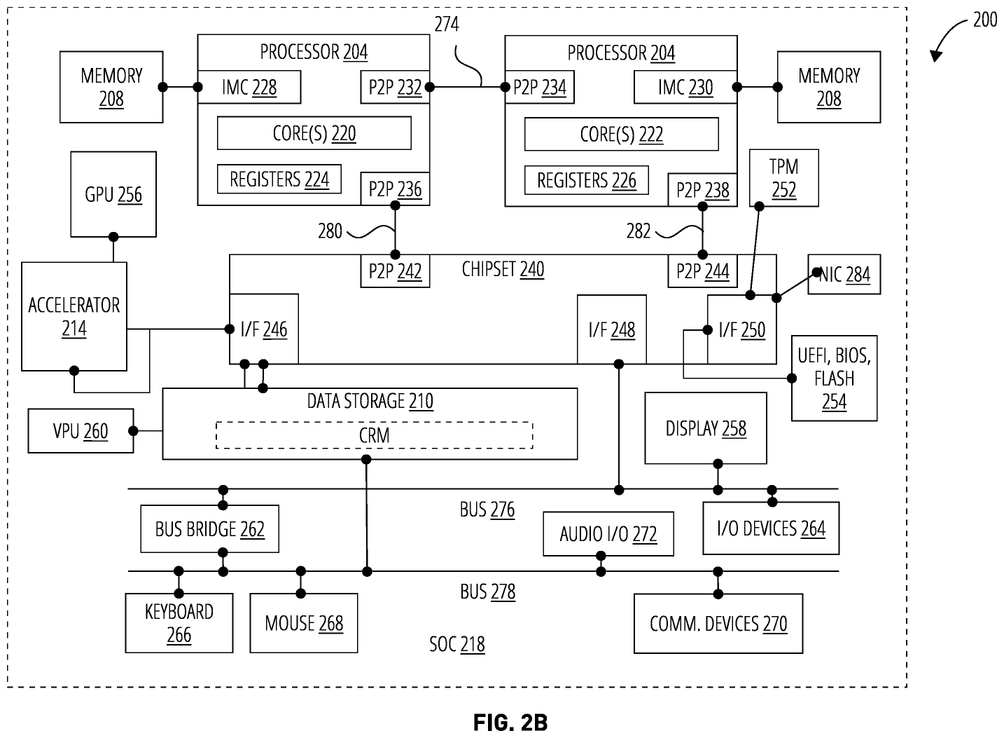

Referring now to FIG. 2A, an illustrative computing device 202 for database acceleration includes a processor 204, an input/output (I/O) subsystem 206, a memory 208, a data storage device 210, and an accelerator 214. The computing device 202 may be embodied as server computer, a rack server, a blade server, a compute node, and/or a sled in a data center.

In use, as described herein, the computing device 202 uses the accelerator 214 to perform compression, decompression, and various filters on elements of a database. The computing device 202 may store compressed databases, decompressed databases, modified databases, etc. to be accessed by the accelerator 214. The accelerator 214 may access data stored in an external memory device such as the main memory 208 to perform the functions as described below. The data may include columns of elements, which may be embodied as packed arrays of unsigned integers. Each element is identified by an index, which may be an integer or other identifier. By accessing a compressed database with the accelerator 214 and performing a decompression followed by one or more filters, the computing device 202 eliminates the need to write a large amount of data associated with a decompressed database to memory 208. That is, only the output of the data processing may be output to memory. This reduces the amount of memory and/or bandwidth that would have been required to perform the decompression, compression, filter, etc., by having the accelerator 214 perform these functions on the data. Accordingly, the computing device 202 may improve memory utilization with accelerator 214, particularly for multi-tenant computing devices 202, such as devices in a data center. Of course, by using the accelerator 214, the computing device 202 may also improve performance over software-only implementations.

The processor 204 may be embodied as any type of processor capable of performing the functions described herein. For example, the processor 204 may be embodied as a single or multi-core processor(s), digital signal processor, microcontroller, or other processor or processing/controlling circuit. Similarly, the memory 208 may be embodied as any type of volatile or non-volatile memory or data storage capable of performing the functions described herein. In operation, the memory 208 may store various data and software used during operation of the computing device 202 such operating systems, applications, programs, libraries, and drivers. The memory 208 is communicatively coupled to the processor 204 via the I/O subsystem 206, which may be embodied as circuitry and/or components to facilitate input/output operations with the processor 204, the memory 208, and other components of the computing device 202. For example, the I/O subsystem 206 may be embodied as, or otherwise include, memory controller hubs, input/output control hubs, sensor hubs, firmware devices, communication links (e.g., point-to-point links, bus links, wires, cables, light guides, printed circuit board traces, etc.) and/or other components and subsystems to facilitate the input/output operations. In some embodiments, the I/O subsystem 206 may form a portion of a system-on-a-chip (SoC) and be incorporated, along with the processor 204, the memory 208, and other components of the computing device 202, on a single integrated circuit chip.

The data storage device 210 may be embodied as any type of device or devices configured for short-term or long-term storage of data such as, for example, memory devices and circuits, memory cards, hard disk drives, solid-state drives, non-volatile flash memory, or other data storage devices. The computing device 202 may also include circuitry for a communications subsystem 212, which may be embodied as any communication circuit, device, or collection thereof, capable of enabling communications between the computing device 202 and other remote devices over a computer network (not shown). The communications subsystem 212 may be configured to use any one or more communication technology (e.g., wired, or wireless communications) and associated protocols (e.g., Ethernet, InfiniBand®, Bluetooth®, Wi-Fi®, WiMAX, 3G, 4G LTE, etc.) to effect such communication.

As shown, the computing device 202 includes an accelerator 214. The accelerator 214 may be embodied as any type of device, such as a coprocessor, application-specific integrated circuit (ASIC), field-programmable gate array (FPGA), functional block, IP core, graphics processing unit (GPU), a processor with specific instruction sets for accelerating one or more operations, or other hardware accelerator of the computing device 202 capable of performing the functions described herein. One example of the accelerator 214 is the Intel® in-memory analytics accelerator (IAA). The accelerator 214 may be coupled to the processor 204 via a high-speed connection interface such as a peripheral bus (e.g., a PCI Express bus) or an inter-processor interconnect (e.g., an in-die interconnect (IDI) or QuickPath Interconnect (QPI)), via a fabric interconnect such as Intel® Omni-Path Architecture, or via any other appropriate interconnect. Additionally, although illustrated as a discrete component separate from the processor 204 and/or the I/O subsystem 206, it should be understood that in some embodiments the accelerator 214, the processor 204, the I/O subsystem 206, and/or the memory 208 may be incorporated in the same package and/or in the same computer chip, for example in the same SoC. In some embodiments, the accelerator 214 may be incorporated as part of a network interface controller (NIC) of the computing device 202 and/or included in the same multi-chip package as the NIC. In some embodiments, the accelerator 214 may be incorporated as part of the I/O subsystem 206 (e.g., as part of a memory controller). More generally, the accelerator may 214 may be packaged in a discrete package, an add-in card, a chipset, a multi-chip module (e.g., a chiplet, a dielet, etc.), and/or an SoC.

The computing device 202 may further include one or more peripheral devices 216. The peripheral devices 216 may include any number of additional input/output devices, interface devices, hardware accelerators, and/or other peripheral devices. For example, in some embodiments, the peripheral devices 216 may include a touch screen, graphics circuitry, a graphical processing unit (GPU) and/or processor graphics, an audio device, a microphone, a camera, a keyboard, a mouse, a network interface, and/or other input/output devices, interface devices, and/or peripheral devices.

FIG. 2B illustrates an embodiment of a system 200. System 200 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the system 200 may have a single processor with one core or more than one processor. Note that the term “processor” refers to a processor with a single core or a processor package with multiple processor cores. In at least one embodiment, the computing system 200 is representative of the components of the computing device 202. More generally, the computing system 200 is configured to implement all logic, systems, logic flows, methods, apparatuses, and functionality described herein with reference to figures herein.

As used in this application, the terms “system” and “component” and “module” are intended to refer to a computer-related entity, either hardware, a combination of hardware and software, software, or software in execution, examples of which are provided by the exemplary system 200. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the unidirectional or bidirectional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in FIG. 2B, system 200 comprises a system-on-chip (SoC) 218 for mounting platform components. System-on-chip (SoC) 218 is a point-to-point (P2P) interconnect platform that includes a first processor 204 and a second processor 204 coupled via a point-to-point interconnect 274 such as an Ultra Path Interconnect (UPI). In other embodiments, the system 200 may be of another bus architecture, such as a multi-drop bus. Furthermore, each of processor 204 and processor 204 may be processor packages with multiple processor cores including core(s) 220 and core(s) 222, respectively. While the system 200 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform may refers to a motherboard with certain components mounted such as the processor 204 and chipset 240. Some platforms may include additional components and some platforms may only include sockets to mount the processors and/or the chipset. Furthermore, some platforms may not have sockets (e.g., SoC, or the like). Although depicted as a SoC 218, one or more of the components of the SoC 218 may also be included in a single die package, a multi-chip module (MCM), a multi-die package, a chiplet, a bridge, and/or an interposer. Therefore, embodiments are not limited to a SoC.

The processor 204 and processor 204 can be any of various commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processor 204 and/or processor 204. Additionally, the processor 204 need not be identical to processor 204.

Processor 204 includes an integrated memory controller (IMC) 228 and point-to-point (P2P) interface 232 and P2P interface 236. Similarly, the processor 204 includes an IMC 230 as well as P2P interface 234 and P2P interface 238. IMC 228 and IMC 230 couple the processor 204 and processor 204, respectively, to respective memories (e.g., memory 208 and memory 208). Memory 208 and memory 208 may be portions of the main memory (e.g., a dynamic random-access memory (DRAM)) for the platform such as double data rate type 4 (DDR4) or type 5 (DDR5) synchronous DRAM (SDRAM). In the present embodiment, the memory 208 and the memory 208 locally attach to the respective processors (e.g., processor 204 and processor 204). In other embodiments, the main memory may couple with the processors via a bus and shared memory hub. Processor 204 includes registers 224 and processor 204 includes registers 226.

System 200 includes chipset 240 coupled to processor 204 and processor 204. Furthermore, chipset 240 can be coupled to data storage 210, for example, via an interface (I/F) 246. The I/F 246 may be, for example, a Peripheral Component Interconnect-enhanced (PCIe) interface, a Compute Express Link® (CXL) interface, or a Universal Chiplet Interconnect Express (UCIe) interface. Data storage 210 can store instructions executable by circuitry of system 200 (e.g., processor 204, processor 204, GPU 256, accelerator 214, vision processing unit 260, or the like). For example, data storage 210 can store instructions for filtering operations, or the like.

Processor 204 couples to the chipset 240 via P2P interface 236 and P2P 242 while processor 204 couples to the chipset 240 via P2P interface 238 and P2P 244. Direct media interface (DMI) 280 and DMI 282 may couple the P2P interface 236 and the P2P 242 and the P2P interface 238 and P2P 244, respectively. DMI 280 and DMI 282 may be a high-speed interconnect that facilitates, e.g., eight Giga Transfers per second (GT/s) such as DMI 3.0. In other embodiments, the processor 204 and processor 204 may interconnect via a bus.

The chipset 240 may comprise a controller hub such as a platform controller hub (PCH). The chipset 240 may include a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 240 may comprise more than one controller hub such as a chipset with a memory controller hub, a graphics controller hub, and an input/output (I/O) controller hub.

In the depicted example, chipset 240 couples with a trusted platform module (TPM) 252 and UEFI, BIOS, FLASH circuitry 254 via I/F 250. The TPM 252 is a dedicated microcontroller designed to secure hardware by integrating cryptographic keys into devices. The UEFI, BIOS, FLASH circuitry 254 may provide pre-boot code.

Furthermore, chipset 240 includes the I/F 246 to couple chipset 240 with a high-performance graphics engine, such as, graphics processing circuitry or a graphics processing unit (GPU) 256. In other embodiments, the system 200 may include a flexible display interface (FDI) (not shown) between the processor 204 and/or the processor 204 and the chipset 240. The FDI interconnects a graphics processor core in one or more of processor 204 and/or processor 204 with the chipset 240.

The system 200 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication can be a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network can be used to connect computers to each other, to the Internet, and to wired networks (which use IEEE 802.3-related media and functions).

Additionally, accelerator 214 and/or vision processing unit 260 can be coupled to chipset 240 via I/F 246. The accelerator 214 is representative of any type of accelerator device (e.g., a data streaming accelerator, cryptographic accelerator, cryptographic co-processor, an offload engine, etc.). The accelerator 214 may be a device including circuitry to accelerate copy operations, data encryption, hash value computation, data comparison operations (including comparison of data in memory 208 and/or memory 208), data filtering, data padding, run length encoding, data scanning, data extraction, and/or data compression. For example, the accelerator 214 may be a USB device, PCI device, PCIe device, CXL device, UCIe device, and/or an SPI device. The accelerator 214 can also include circuitry arranged to execute machine learning (ML) related operations (e.g., training, inference, etc.) for ML models. Generally, the accelerator 214 may be specially designed to perform computationally intensive operations, such as hash value computations, comparison operations, cryptographic operations, and/or compression operations, in a manner that is more efficient than when performed by the processor 204 or processor 204. Because the load of the system 200 may include hash value computations, comparison operations, cryptographic operations, and/or compression operations, the accelerator 214 can greatly increase performance of the system 200 for these operations.

The accelerator 214 may include one or more dedicated work queues and one or more shared work queues (each not pictured). Generally, a shared work queue is configured to store descriptors submitted by multiple software entities. The software may be any type of executable code, such as a process, a thread, an application, a virtual machine, a container, a microservice, etc., that share the accelerator 214. For example, the accelerator 214 may be shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 214 via a non-posted write (e.g., a deferred memory write (DMWr)). One example of an instruction that atomically submits a work descriptor to the shared work queue of the accelerator 214 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 214. The dedicated work queue may accept job submissions via commands such as the movdir64b instruction.

Various I/O devices 264 and display 258 couple to the bus 276, along with a bus bridge 262 which couples the bus 276 to a second bus 278 and an I/F 248 that connects the bus 276 with the chipset 240. In one embodiment, the second bus 278 may be a low pin count (LPC) bus. Various devices may couple to the second bus 278 including, for example, a keyboard 266, a mouse 268 and communication devices 270.

Furthermore, an audio I/O 272 may couple to second bus 278. Many of the I/O devices 264 and communication devices 270 may reside on the system-on-chip (SoC) 218 while the keyboard 266 and the mouse 268 may be add-on peripherals. In other embodiments, some or all the I/O devices 264 and communication devices 270 are add-on peripherals and do not reside on the system-on-chip (SoC) 218.

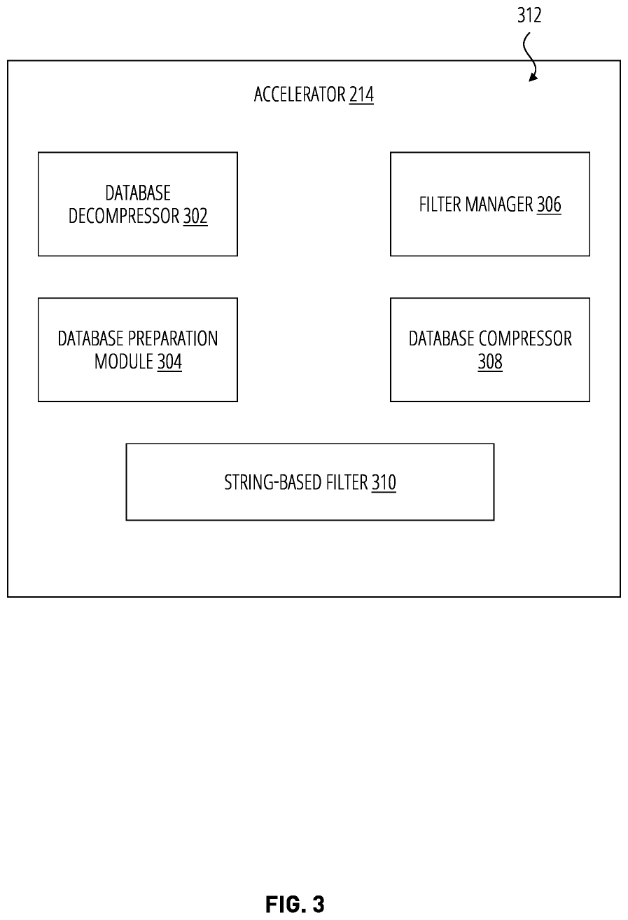

Referring now to FIG. 3, in an illustrative embodiment, the accelerator 214 establishes an environment 312 during operation. The illustrative environment 312 includes a database compressor 308, a database preparation module 304, a filter manager 306 and a database compressor 308. The various components of the environment 312 may be embodied as hardware, firmware, software, or a combination thereof. As such, in some embodiments, one or more of the components of the environment 312 may be embodied as circuitry or collection of electrical devices (e.g., database compressor circuitry 302, database preparation circuitry 304, filter manager circuitry 306, and/or database compressor circuitry 308). It should be appreciated that, in such embodiments, one or more of the database compressor circuitry 302, the database preparation circuitry 304, the filter manager circuitry 306, and/or the database compressor circuitry 308 may form a portion of the processor 204, the I/O subsystem 206, the accelerator 214, and/or other components of the computing device 202. Additionally, in some embodiments, one or more of the illustrative components may form a portion of another component and/or one or more of the illustrative components may be independent of one another.

The database decompressor 302 is configured to retrieve a compressed database from data storage 210 or memory 208 and perform a decompression of the one or more compressed elements of the compressed elements. The result generates a decompressed database that includes the decompressed elements. These elements may be stored in a columnar format or any other format suitable for a database to be manipulated. Each element may be identified by an index as described above. The index may be referenced for an output of the element. For example, if the accelerator 214 is performing a determination of which values of the database are above a threshold value, the output may contain the index of each element that is above the threshold.

The database preparation module 304 is configured to prepare the elements of the database for a filter operation. To do so, the database preparation module 304 manipulates the decompressed elements from the database decompressor 302 to a target format to be processed by the filter operation. For example, the database preparation module 304 may perform bit manipulations such as data re-alignment, bit re-mapping, bit broadcasting, or other modifications. The data preparation may depend on specific database attributes such as data element sizes and/or database filter operations. Additionally, in some embodiments, the database preparation module 304 may manipulate data elements directly from the source, without decompression. The database preparation module 304 may also prepare the output elements from the filter operation. The database preparation module 304 may expand or decrease the bit width of each element or convert the elements into an array of indices. The elements may include a bit vector and each index of the array of indices corresponds to a set bit in the bit vector.

The filter manager 306 is configured to manage the various filter operations the accelerator 214 may perform on the database elements. The filter operations may include one or more operations performed in connection with a database query. The filter manager 306 may perform a filter operation such as an extract, a bitwise logic operation, a scan, a generate, a translate, an aggregate, a sort, or a set membership or any combination of those operations after preparation of the database elements to the target format. In some embodiments, the filter operations may include other filters that may be performed on a database. The filter manager 306 may also subsequently perform another filter operation after performing a first filter operation. For example, to perform an aggregate, the filter manager 306 may aggregate the output elements to generate aggregate data which may include computing a population count, a minimum, or a maximum. One of the filters that the filter manager 306 facilitates is the string-based filter 310, which operates as described herein.

The database compressor 308 is configured to compress the output of the filter manager 306 to generate compressed elements of a compressed database, which may reduce the amount of data written to memory 208. In some embodiments, the database compressor 308 may perform compression after performing the filter operation with the filter manager 306 or after a series of filter operations with the filter manager 306. The compression algorithm used may or may not be the same algorithm used to decompress the data. The compression algorithm may be data or operation specific (e.g., implied, or expressly configured). After compression of the output elements, the accelerator 214 may write the compressed output to memory 208. Alternatively, the accelerator 214 may write the output to memory 208 without compressing the output.

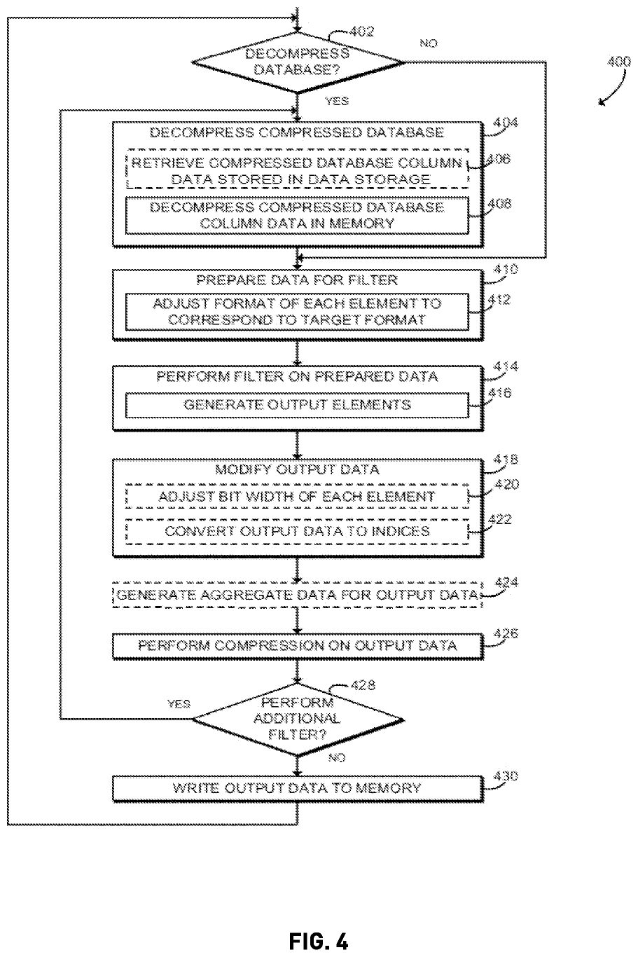

Referring now to FIG. 4, the computing device 202 may execute a method 400 for database acceleration. It should be appreciated that, in some embodiments, the operations of the method 400 may be performed by one or more components of the environment 312 of the accelerator 214 of the computing device 202. The method 400 begins in block 402, in which the accelerator 214 determines whether to decompress a database in memory 208 or in data storage 210. This may be determined based on whether there is a compressed database in memory 208 or in data storage 210 that needs to be processed by a filter operation. If the accelerator 214 determines that decompression is not necessary (e.g., the database in the memory 208 is not compressed), then the method 400 proceeds to block 410, described below. If the accelerator 214 determines to decompress the database, the method 400 advances to block 404.

In block 404, the accelerator 214 decompresses the compressed database. The compressed database may be stored in any lossless compression format, including dictionary encoding, run length encoding (RLE), or an LZ77-based algorithm such as DEFLATE. In the illustrative embodiment, the database column data is compressed using DEFLATE, and is decompressed by the accelerated hardware function of the accelerator 214. To decompress the database, in some embodiments, the accelerator 214 may retrieve compressed database column data that is stored in a data storage 210 in block 406. After the compressed database column data is in memory 208, the accelerator 214 may decompress the compressed database column data to generate decompressed elements in block 408. The decompressed elements may be embodied as a packed array of n-bit unsigned integers, wherein the width of the integers may depend on the database column, schema, or other data definition. The input data may be organized in big-endian or little-endian format. As a special case where n=1, the input data may be embodied as a bit vector.

After decompressing the data, the accelerator 214 prepares the data from the decompression for a filter operation in block 410. In block 412, the accelerator 214 may adjust the format of each element to correspond to a target format for a specified filter operation. For example, the accelerator may expand or decrease the bit width of each element or convert the elements into an array of indices. Each filter operation may specify what format it requires each element to be in to be processed by that filter operation. The accelerator 214 may format the elements based on those specifications.

In block 414, the accelerator 214 performs a filter on the prepared data. The filters may include operations performed during a database query. For example, the filter may be embodied as an extract, a bitwise logic operation, a scan, a generate, a translate, an aggregate, a sort, or a set membership. In some embodiments, the filters may perform operations in hardware that are inefficient or otherwise slow to perform in software using the processor 204, leaving other operations to the processor 204. Certain filters may require two or more input streams of data elements. In some embodiments, when the accelerator 214 processes two input streams, the decompression engine of the accelerator 214 must be bypassed (e.g., the column data may not be compressed), and one of the two input streams must be a bit vector. In those embodiments, the decompression and the filtering may be performed in separate passes, for example using an intermediate memory buffer. Of course, in other embodiments the accelerator 214 may not have any restrictions on the composition of the input data streams. For example, in some embodiments, each input stream may be decompressed or not independent of the other stream, and in some embodiments multiple input streams may be used that are not bit vectors.

In block 416, the accelerator 214 generates output elements from performing the filter in block 414. The output elements may be embodied as a bit vector and/or a packed array of data elements similar to the input data. The output data may have a different bit width and/or a different number of elements as compared to the input data. For example, the extract filter may perform width conversion for the data elements or pad the data elements. As another example, the bitwise logic operation may perform a bitwise logic operation (e.g., AND, OR, XOR) on each element of two streams of input data elements. The scan element may compare elements against a lower bound and an upper bound and output a bit vector. Thus, with careful selection of bounds the scan filter may be used to perform equality, inequality, and mathematical comparison operations. The generated filter may be used to generate a column of constant and/or random data. The sort filter may generate a sorted list of data elements.

After generating the output elements, the accelerator 214 may modify the output data in block 418. To modify the output data, in some embodiments, the accelerator 214 adjusts the bit width of each element in block 420. For example, the accelerator 214 may add leading zeroes to each element. In addition, in some embodiments, the accelerator 214 may convert the output data to indices in block 422. For example, this may include outputting an array of indices corresponding to data elements that satisfy a specified condition.

In some embodiments, after modifying the output data, in block 424, the accelerator 214 generates aggregate data for the output data. This may include computing a population count, a minimum, or a maximum of the output data. The population count may be embodied as the number of non-zero bits in a bit vector. The accelerator 214 may also identify the index of the first and last set bit in the bit vector. In some embodiments, some or all of the output data may be suppressed. For example, when generating the population count, the accelerator 214 may suppress the bit vector and output only the population count.

In block 426, the accelerator 214 may perform compression on the output data. After performing compression, the accelerator 214 determines whether to perform an additional filter in block 428. If the accelerator 214 determines that another filter needs to be performed, the method 400 returns to block 404 to continue processing the data. If the accelerator 214 determines that another filter is not needed, the method 400 advances to block 430, in which the accelerator 214 writes the output data, which may be compressed, to the memory 208. After writing the output data, the method 400 loops back to block 402 to continue performing database operations.

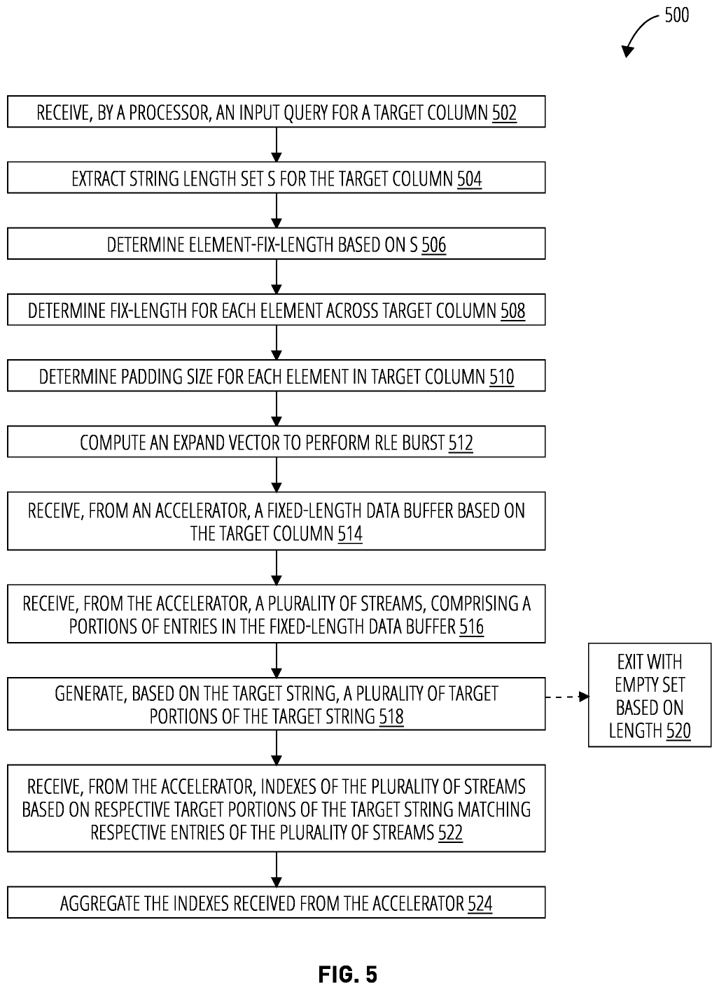

FIG. 5 illustrates an example method 500 for filtering records in a database using a string-based filter 310 in accordance with one or more embodiments. In some embodiments, the string-based filter 310 is performed using the accelerator 214 to improve the efficiency of the filtering. Although the example method 500 depicts a particular sequence of operations, the sequence may be altered without departing from the scope of the present disclosure. For example, some of the operations depicted may be performed in parallel or in a different sequence that does not materially affect the function of the method 500. In other examples, different components of an example device or system that implements the method 500 may perform functions at substantially the same time or in a specific sequence.

The method 500 is now described using the example data shown in FIG. 1. Consider that a string column filter operation is to be performed on table 102 to filter out the set of record indexes that match a specified input string which is required while executing SQL clause like “SELECT <column-x>FROM <table>WHERE “customer”=“Eric”.” Here, the input query includes, as a first input, specified target string; in this case string “Eric.” Further, the input query includes, as a second input, specified data buffer containing the strings from which the specified target is to be selected (or not). The data buffer is based on the target column in the table, for example, column “customer” in the table 102. In some examples, the specified data buffer includes a string length followed by the string, however, other formats can be used. For example, the specified string for the example data: {5, “Jessy”, 4, “Eric”, 5, “James”, 6, “George”, 9, “Kissinger”, 3, “Bob”, . . . }. For the specified query and buffer, the query-results 106 include a set of indexes of matching records from the table 102 in which the customer is “Eric.” Thus, the query-results 106 include {1, 10, . . 4095}.

It is understood that the query may be presented in any other format, for example, using another query language. It is also understood that the technical solutions herein are not restricted to using the data shown and/or the input string(s) shown here; and that in other embodiments, different parameters and data may be used. The method 500 can be executed as a specific sequence of steps performed using a combination of software and hardware, or a combination thereof.

The method 500 includes receiving an input query at block 502. The input query can be a SQL query or any other type of query to request specific data from the table 102. The input query includes a string-based filter 310, which specifies a target string (e.g., “Eric”) and a target data buffer, which is based on the target column (e.g., “customer”). The string-based filter 310 requests filtering the data in the table 102 so that only those rows are selected that include the target string in the target column. The input query can be provided manually by a user directly via a user interface and/or automatically by a computer program that is executing on the processor 204.

According to some examples, the method 500 includes extracting a string length set S for the target column at block 504. In the above example scenario, S={5, 4, 5, 6, 9, 3, . . . }. Each entry in S represents the length of the string at a corresponding index in the target column in the table 102. Further, at block 506, an element-fix-length is computed. The element-fix-length is based on the maximum bit width that the accelerator 214 can process. In some examples, the processor 204 determines the maximum bit width of the accelerator 214 at an earlier stage and uses this bit width for computing the element-fix-length. For example, consider that the maximum bit width of the accelerator 214 is 4 bytes (e.g., 32 bits). Accordingly, for the ongoing example for table 102 and column customer, max-length (S)=9. Therefore, for the 4-byte bit width, element-fix-length=((max-length+(max-bit-width-1))/max-bit-width)* max-bit-width=((9+3)/4)*4=12.

Further, at block 508, the method 500 includes compensating each element using a computed prefix (string length) and deriving a fix-length for each element in the target column. The computed prefix is based on the maximum bit width of the accelerator 214, fix-length=element-fix-length+max-bit-width. Accordingly, in the ongoing example, for each element in the customer column, fix-length=12+4=16.

At block 510, the method 500 includes computing a padding size for each element in the target column in order to pad each element to the fix-length. The pad-size=fix-length—prefix-length—element-length. Accordingly, in the example of table 102, the (prefix-length+element-length, pad-size) result in the pairs: (9, 7), (8, 8), (9, 7), (10, 6), (13, 3), (8,8), . . . . In some embodiments, S and maximum length from S can be precomputed and stored as metadata in each column of the table 102. In some embodiments, database applications have that type of metadata per columnar unit. In such embodiments, where the data is available the method 500 can initiate from block 512.

Armed with the above information, at block 512, the method 500 includes computing an expand vector to perform a run length encoding (RLE) operation. The expand vector is generated and setup in a manner that the accelerator 214 can perform the RLE operation in a burst mode (e.g., parallel mode) to improve the efficiency of the operation. An example expand vector for the scenario of table 102 is depicted below.

The expand vector includes two values, in the depicted example, 1 and 0. For each element in the targeted column (e.g., customer), there are two entries in the expand vector. The first entry includes the first value (1) repeated for the prefix-length+element-length times, followed by a second entry that includes the second value (0) repeated for the pad-size number of times.

Further, at block 514, a fixed-length data buffer is generated that includes an entry for each element in the target column. Each entry of the fixed-length data buffer includes two portions, a first portion indicative of a length of the corresponding element from the target column in the table 102, and a second portion based on the element (e.g., string) and the corresponding pad-size. The fixed-length data buffer is generated using the accelerator 214, for example, using RLE capabilities of the accelerator 214 in some embodiments. The fixed-length data buffer for the ongoing example is depicted below.

Fixed-length Data Buffer Example:

5, “Jessy0000000”, 4, “Eric00000000”, 5, “James0000000” 6,
“George000000”, 9, “Kissinger000”,...

Thus, respective entries of the fixed-length data buffer are based on respective elements of the plurality of strings in the target column. Every second portion in the fixed-length data buffer is of the same length—the fixed-length. Each second portion includes the corresponding string (element) from the target column padded with a known value (e.g., 0), which is repeated pad-size number of times. The second portion is referred to as a “segment” herein.

At block 516, each segment in the fixed-length data buffer is split into a predetermined number of portions (e.g., 4, 8, 16, etc.), where each value is of length maximum bit-width of the accelerator 214. The splitting of the segments is performed using the accelerator 214 in some embodiments. For example, a select feature of the accelerator 214 can be used in some embodiments. Such select feature (e.g., qp1 operation.qp1 op select) requires a mask to indicate how the splitting is to be performed. The accelerator 214 returns a number of streams in parallel, each stream including a split portion of each segment. In other words, the bytes of each segment are scattered in the corresponding streams generated by the accelerator 214 by splitting the segments. In the ongoing example scenario, the segments are split into four streams of 4 bytes (maximum bit-width) each. The split streams of the customer table 102 are illustrated below.

Example Split Streams:

1^{st} stream:
5, 4, 5, 6, 9, ...
2^{nd} stream:
“Jess”, “Eric”, Jame”, “Geor”, “Kiss”, ...
3^{rd} stream:
“y000”, “0000”, “s000”, “ge00”, “inge”, ...
4^{th} stream:
“0000”, “0000”, “0000”, “0000”, “r000”, ...

Accordingly, the method 500 includes receiving from the accelerator 214, a plurality of streams, respective ones of the plurality of streams to comprise a portion of respective entries in the fixed-length data buffer at block 516.

According to some examples, the method 500 includes generating, based on the target string, a plurality of target portions for the target string at block 518. Generating the target portions includes expanding the target string (e.g., “Eric”) based on the element-fix-length (computed at block 506). If the length of the target string (“Eric”) exceeds the element-fix-length that was computed, it is deemed that there is no record matching the target string in the target column. In this case, an empty set is output, and execution of the method 500 can be stopped, at block 520. For the example target string “Eric” the expanded target string is “Eric0000000” (seven O's) based on the operations described earlier herein.

Further, the expanded target string is split to generate the target portions. Similar to the splitting in block 516, the splitting of the expanded target string is performed based on the maximum bit-width of the accelerator 214. Accordingly, in the ongoing example scenario, the target portions are as shown below.

Example Target Portions:

1^{st} 4-bytes:
4
2^{nd} 4-bytes:
“Eric”
3^{rd} 4-bytes:
“0000”
4^{th} 4-bytes:
“0000”

In some embodiments, the expansion and consequent splitting of the target string is performed by the processor 204.

According to some examples, the method 500 includes receiving, from the accelerator, indexes of the plurality of streams based on respective target portions of the target string matching respective entries of the plurality of streams at block 522. The selection of the indexes of the entries from the split streams that match corresponding target portions of the expanded target string is performed using the accelerator 214. In some embodiments, the selection is performed using the scan feature of the accelerator 214, which facilitates improved efficiency.

The scan feature can be accessed via an application programming interface operation (e.g., qp1_operation.qp1 op scan). In some embodiments, the scan operation outputs a bit-vector in which the 1-bits correspond to input elements that satisfy a numerical relationship. In other words, the scan operation can search for elements that are equal to, not equal to, greater than, etc., a specified value, or for those values that fall within an inclusive range. The value and/or the range can be specified as an input to the operation. The number of output bits (e.g., the number of output elements) is the same as the number of input elements.

According to some examples, the method 500 includes aggregating the indexes received from the accelerator at block 524. The aggregation is performed using bitwise “AND” operation in some embodiments. The bitwise “AND” is performed in parallel using the accelerator 214 in some embodiments. In some embodiments, the bitwise “AND” operation can be performed using vector operations (e.g., AVX instructions). For example, for the customer table 102 the output of the aggregated indexes includes {1, 10, . . . , 4095}. For database applications that can process bit vectors rather than the indices list, the output of the bitwise AND can be used directly, without conversion of the output to integer indexes. In other types of database applications, the output of the bitwise “AND” is converted to a list of indexes.

The operations of method 500 described herein can be performed using a combination of the accelerator 214 and the processor 204 to improve the efficiency of executing the method 500. The gain in efficiency may include reduction in time, reduction in compute cycles of the processor 204, reduction in latency, reduction in memory reads/writes, and other such metrics, required for executing the string-based filter 310. In several embodiments, at least a 30% gain in efficiency can be realized by using the accelerator 214 for several operations as described herein. In other words, at least 30% of the execution of the string-based filter 310 can be offloaded by the processor 204 to the accelerator 214 using the technical solutions described herein.

In some embodiments, a database such as the database table 102 may be used as training data, e.g., to train artificial intelligence (AI) models such as machine learning (ML) models, neural networks, etc. In such embodiments, errors may be identified during training, such that the AI model needs to be re-trained. One such error may be based on a portion or subset of the training data. In such embodiments, the method 500 may be used to identify the subset of the training data in the database table 102. The identified subset may then be used to re-train the AI model.

Accordingly, the technical solutions described herein improve computing technology, particularly database access technology, and more particularly string-based filters 310. The improvement is achieved by using the accelerator 214, which can be a hardware co-processor. The processor 204 can offload one or more operations to the accelerator 214 enabling the processor 204 to complete other tasks. Such parallelization improves the overall efficiency of the computing device 202, and also improves efficiency of the string-based filters 310 in particular.

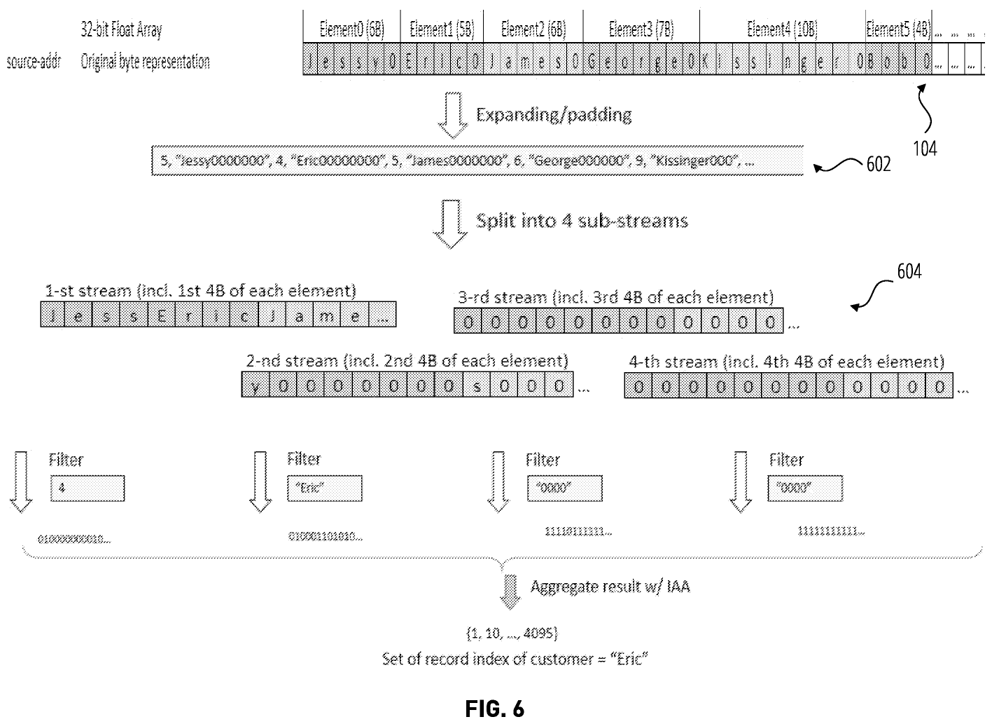

FIG. 6 depicts the execution of the method 500 for the example data in the target column 104 (customer column) from the table 102 according to an embodiment. The column 104 is represented as a 32-bit array source-addr. Consider that K is the size in bytes of the data type, N is the number of elements in the data sequence. In the example case, K=4, and N=10; however, they can vary in other embodiments. By using the scan operation of the accelerator 214, the ‘0’ position in the array is located to determine lengths of each string in the column 104. For example, the scan operation can be operated by providing as input parameters the source-addr, a bit-width=8. The scan operation executing on the accelerator 214 outputs a vector indicating the position of ‘0’, which in this case is {5, 10, 16, 23, 33, 37, . . . }. Based on the output of the scan operation, the vector S for the lengths can be computed as S={6, 5, 6, 7, 4, . . . }. In some embodiments, the lengths are computed by the processor 204 using the output from the accelerator 214. Further, the processor 204 can generate a vector representing padding size for a predetermined length, say 16 bytes. As noted herein, the vector indicative of the padding size can be expressed as {6,10) (5,11) (6,10) (7,9) (10, 6) (4,12). . .}.

Further, the accelerator 214 is used to generate a bit vector using RLE burst operation. The input to the RLE burst operation includes the 32-bit width vector {6,10,5,11,6,10,7,9,10,6,4, 12,}, and a 4099-bit, 1-bit width vector {10101010 . . . }. The output of the RLE burst operation is an expand-vector that the accelerator 214 generates. The expand-vector in this particular example is {1111110000000000111110000000000011111100000000001111000000000000. . .}.

Each element in the source-addr is then processed by the accelerator 214 to expand each element to 16 bytes by padding with ‘0’s. Any other value can be used for padding in other examples. The expansion is performed using the expand operation of the accelerator 214 by providing as input the source-addr, and the bit-width (in this case 8). The expand operation also takes the expand-vector as input. The output is a padded expand-vector 602 as shown.

The padded expand-vector 602 is split into a predetermined number of data sub-stream 604. The splitting is performed using a scan operation of the accelerator 214. The splitting generates a first sub-stream 604 that includes the first X bits of each element in the padded expand-vector 602, a second sub-stream 604 that includes the second X bits of each element in the padded expand-vector 602, a third sub-stream 604 that includes the third X bits of each element in the padded expand-vector 602, and so on. Here, X is a predetermined value, for example 4 Bytes. In the example of table 102, four sub-streams 604 are generated.

Next, the sub-streams 604 are filtered using the accelerator 214 based on the expanded target string. In this case, for the target string “Eric,” the first sub-stream 604 is filtered using 4-Byte vector “010000000010 . . . ”; the second sub-stream 604 is filtered using 4-Byte vector “010001101010 . . . ”; the third sub-stream 604 is filtered using 4-Byte vector “11110111111 . . . ”; and the fourth sub-stream 604 is filtered using 4-Byte vector “11111111111 . . . ”. The results of filtering the sub-streams 604 are aggregated to determine the set of record indexes that contain the customer “Eric.”

In some embodiments, by using the accelerator 214 as described herein, the data transformations required for executing the string-based filter 310, as depicted in FIG. 6, are performed in memory, without expensive writes to storage. Further, by using the accelerator 214 to perform a subset of the operations, compute cycles from the processor 204 are freed, which can be used for different/additional operations that are more conducive to be performed by the processor 204 (than the accelerator 214).

In embodiments described herein a plain encoding is used whenever a more efficient encoding is not available. In the plain encoding, the data is stored in the following format: BOOLEAN: Bit Packed, LSB first; INT32: 4 bytes little endian; INT64: 8 bytes little endian; FLOAT: 4 bytes IEEE little endian; DOUBLE: 8 bytes IEEE little endian; BYTE ARRAY: length in 4 bytes little endian followed by the bytes contained in the array; FIXED LEN BYTE ARRAY: the bytes contained in the array.

In some embodiments, an apparatus includes an accelerator 214, and a processor 204 operable to execute one or more instructions. The processor 204 receives an input string targeting a data buffer comprising a plurality of strings. The processor 204 receives from the accelerator 214, a fixed-length data buffer based on the data buffer, respective ones of a plurality of entries of the fixed-length data buffer based on respective ones of the plurality of strings. The processor 204 receives from the accelerator 214, a plurality of streams, respective ones of the plurality of streams to comprise a portion of respective entries in the fixed-length data buffer. The processor 204 generates, based on the input string, a plurality of target portions of the input string. The processor 204 receives from the accelerator 214, indexes of the plurality of streams based on respective target portions of the input string matching respective entries of the plurality of streams. The processor 204 aggregates the indexes received from the accelerator 214.

According to some embodiments, a method includes receiving, by a processor 204, an input string targeting a data buffer comprising a plurality of strings. The method further includes receiving from an accelerator 214, a fixed-length data buffer based on the data buffer, respective ones of a plurality of entries of the fixed-length data buffer based on respective ones of the plurality of strings. The method further includes receiving from the accelerator 214, a plurality of streams, respective ones of the plurality of streams to comprise a portion of respective entries in the fixed-length data buffer. The method further includes generating, based on the input string, a plurality of target portions of the input string. The method further includes receiving from the accelerator 214, indexes of the plurality of streams based on respective target portions of the input string matching respective entries of the plurality of streams. The method further includes aggregating the indexes received from the accelerator 214.

In some embodiments, the fixed-length data buffer generated using a run length encoding operation of the accelerator 214. In some embodiments, the fixed-length data buffer is generated using a splitting operation of the accelerator 214. In some embodiments, the fixed-length data buffer is generated using an aggregation operation of the accelerator 214. In some embodiments, the fixed-length data buffer is generated using a filtering operation of the accelerator 214.

According to some embodiments, a circuitry includes a processor 204 and an accelerator 214 coupled to the processor 204. The processor is configured to execute an instruction to identify indexes of a target string in a data buffer comprising a plurality of strings, wherein the target string and the data buffer are stored in memory. Execution of the instruction comprises generating, by the processor 204, using the accelerator 214, a fixed-length data buffer based on the data buffer, the fixed-length data buffer comprises a plurality of entries respectively corresponding to the strings in the data buffer, wherein an entry in the fixed-length data buffer comprises a corresponding string from the data buffer appended with padding bits to conform the entry to a predetermined length. Execution of the instruction further comprises splitting, by the processor 204, using the accelerator 214, the fixed-length data buffer into a plurality of streams, each stream comprising a split portion of each entry in the fixed-length data buffer. Execution of the instruction further comprises generating, by the processor 204, a fixed-length target string based on the target string, wherein the fixed-length target string comprises the target string appended with padding bits to conform the fixed-length target string to the predetermined length. Execution of the instruction further comprises splitting, by the processor 204, the fixed-length target string into a plurality of target portions corresponding to the number of streams into which the fixed-length data buffer is split. Execution of the instruction further comprises filtering, by the processor 204, using the accelerator 214, indexes from each of the streams wherein an index from a stream is filtered in response to the split portion at that index in the stream matching a corresponding target portion from the target string. Execution of the instruction further comprises aggregating, by the processor 204, filtered indexes from the plurality of streams by performing a bitwise AND operation. Execution of the instruction further comprises outputting, by the processor 204, the aggregated filtered indexes.

In some embodiments, a first entry corresponding to the first string comprises a first portion indicative of a length of the first string, and a second portion that comprises the first string appended with the padding bits. In some embodiments, the first string is appended with a number of padding bits depending on the length of the first string.

In some embodiments, the fixed-length target string comprises a first portion indicative of a length of the target string, and a second portion that comprises the target string appended with the padding bits.

In some embodiments, the number of streams in the plurality of streams is based on maximum length of datatype used by the accelerator.

In some embodiments, aggregating is performed using the accelerator 214.

In some embodiments, prior to outputting, the processor 204 converts aggregated indexes into integers. In some embodiments, the conversion is performed using the accelerator 214.

In some embodiments, generating, by the processor 204, an expand-vector is based on the data buffer, and the expand-vector comprises a plurality of fixed-length entries respectively corresponding to the strings in the data buffer, a first fixed-length entry corresponding to the first string comprises a first portion indicative of a length of the first string. In some cases, the first portion of the first string indicates a sum of the length of the first string and a predetermined length of an integer.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose, or it may comprise a general-purpose computer as selectively activated or reconfigured by a computer program stored in the computer. The procedures presented herein are not inherently related to a particular computer or other apparatus. Various general-purpose machines may be used with programs written in accordance with the teachings herein, or it may prove convenient to construct more specialized apparatus to perform the required method steps. The required structure for a variety of these machines will appear from the description given.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The various elements of the devices as previously described with reference to figures herein may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

The following examples pertain to further embodiments, from which numerous permutations and configurations will be apparent.

Example 1 includes an apparatus, comprising: an interface to a processor; and accelerator circuitry to: receive a data buffer from the processor, the data buffer to comprise a plurality of strings, the data buffer to be based on an input string; generate a fixed-length data buffer based on the data buffer, respective ones of a plurality of entries of the fixed-length data buffer based on respective ones of the plurality of strings; generate a plurality of streams, respective ones of the plurality of streams to comprise a portion of respective entries in the fixed-length data buffer; receive, from the processor based on the input string, a plurality of target portions of the input string; generate indexes of the plurality of streams based on respective target portions of the input string matching respective entries of the plurality of streams; and transmit the indexes to the processor.

Example 2 includes the subject matter of example 1, wherein the fixed-length data buffer is to be generated based on a run length encoding operation of the accelerator circuitry.

Example 3 includes the subject matter of example 1, wherein the fixed-length data buffer is to be generated based on a splitting operation of the accelerator circuitry.

Example 4 includes the subject matter of example 1, wherein the fixed-length data buffer is to be generated based on an aggregation operation of the accelerator circuitry.

Example 5 includes the subject matter of example 1, wherein the fixed-length data buffer is to be generated based on a filtering operation of the accelerator circuitry.

Example 6 includes the subject matter of example 1, wherein an entry in the fixed-length data buffer is to comprise a corresponding string from the data buffer appended with padding bits to conform the entry to a predetermined length.

Example 7 includes the subject matter of example 6, wherein a target portion from the target portions is to comprise the input string appended with padding bits to conform the target portion to the predetermined length.

Example 8 includes the subject matter of example 1, wherein the plurality of streams are to be generated by splitting the fixed-length data buffer into the plurality of streams, each stream to comprise a split portion of an entry in the fixed-length data buffer.

Example 9 includes the subject matter of example 8, wherein the accelerator circuitry is to filter an index from a stream in response to the split portion at that index in the stream matching a corresponding target portion from the input string.

Example 10 includes the subject matter of example 8, wherein the accelerator circuitry is to aggregate the indexes based on a bitwise AND operation prior to transmitting the indexes to the processor.

Example 11 includes a non-transitory computer-readable storage medium, the computer-readable storage medium including instructions that when executed by an accelerator device, cause the accelerator device to: receive a data buffer from a processor, the data buffer to comprise a plurality of strings, the data buffer to be based on an input string; generate a fixed-length data buffer based on the data buffer, respective ones of a plurality of entries of the fixed-length data buffer based on respective ones of the plurality of strings; generate a plurality of streams, respective ones of the plurality of streams to comprise a portion of respective entries in the fixed-length data buffer; receive, from the processor based on the input string, a plurality of target portions of the input string; generate indexes of the plurality of streams based on respective target portions of the input string matching respective entries of the plurality of streams; and transmit the indexes to the processor.

Example 12 includes the subject matter of example 11, wherein the fixed-length data buffer is to be generated based on a run length encoding operation of the accelerator.

Example 13 includes the subject matter of example 11, wherein the fixed-length data buffer is to be generated based on a splitting operation of the accelerator.

Example 14 includes the subject matter of example 11, wherein the fixed-length data buffer is to be generated based on an aggregation operation of the accelerator.

Example 15 includes the subject matter of example 11, wherein the fixed-length data buffer is to be generated based on a filtering operation of the accelerator.

Example 16 includes the subject matter of example 11, wherein an entry in the fixed-length data buffer is to comprise a corresponding string from the data buffer appended with padding bits to conform the entry to a predetermined length.

Example 17 includes the subject matter of example 16, wherein a target portion from the target portions is to comprise the input string appended with padding bits to conform the target portion to the predetermined length.

Example 18 includes the subject matter of example 11, wherein the plurality of streams is to be generated by splitting, by the accelerator, the fixed-length data buffer into the plurality of streams, each stream comprising a split portion of an entry in the fixed-length data buffer.

Example 19 includes the subject matter of example 18, wherein an index from a stream is filtered in response to the split portion at that index in the stream matching a corresponding target portion from the input string.

Example 20 includes the subject matter of example 18, wherein indexes are to be aggregated by performing a bitwise AND operation.

Example 21 includes a method, comprising: receiving, by a processor, an input string to filter records in a dataset; generating, by the processor, a plurality of target portions based on the input string; and causing, by the processor, an accelerator device to filter the records in the dataset based on the target portions and by using a run length encoding feature of the accelerator device.

Example 22 includes the subject matter of example 21, wherein the processor causes the accelerator device to filter the records using the run length encoding function to generate a fixed-length data buffer based on the dataset.

Example 23 includes the subject matter of example 22, wherein the processor causes the accelerator device to filter the records based on the fixed-length data buffer by splitting the fixed-length data buffer into a predetermined number of data streams that are compared with the target portions.

Example 24 includes the subject matter of example 23, wherein the processor causes the accelerator device to filter the records using an aggregation function to aggregate results of the comparing of the target portions with the data streams.

Example 25 includes the subject matter of example 21, wherein the generating the plurality of target portions comprises generating an expanded input string and splitting the expanded input string into the plurality of target portions.

Example 26 includes the subject matter of example 22, wherein an entry in the fixed-length data buffer is to comprise a corresponding string from the input string appended with padding bits to conform the entry to a predetermined length.

Example 27 includes the subject matter of example 22, further comprising receiving, from the accelerator, a plurality of streams, respective ones of the plurality of streams to comprise a portion of respective entries in the fixed-length data buffer.

Example 28 includes the subject matter of example 22, wherein the plurality of streams is to be generated by splitting, by the accelerator, the fixed-length data buffer into the plurality of streams, each stream comprising a split portion of an entry in the fixed-length data buffer.

Example 29 includes the subject matter of example 28, wherein an index from a stream is filtered in response to the split portion at that index in the stream matching a corresponding target portion from the input string.

Example 30 includes the subject matter of example 29, wherein indexes are to be aggregated by performing a bitwise AND operation.

Example 31 includes an apparatus, comprising: means for receiving an input string to filter records in a dataset; means for generating a plurality of target portions based on the input string; and means for causing an accelerator device to filter the records in the dataset based on the target portions and by using a run length encoding feature of the accelerator device.

Example 32 includes the subject matter of example 31, wherein the records are filtered using the run length encoding function to generate a fixed-length data buffer based on the input string.

Example 33 includes the subject matter of example 32, wherein the fixed-length data buffer is to be generated based on a splitting operation of the accelerator.

Example 34 includes the subject matter of example 32, wherein the fixed-length data buffer is to be generated based on an aggregation operation of the accelerator.

Example 35 includes the subject matter of example 32, wherein the fixed-length data buffer is to be generated based on a filtering operation of the accelerator.

Example 36 includes the subject matter of example 32, wherein an entry in the fixed-length data buffer is to comprise a corresponding string from the data buffer appended with padding bits to conform the entry to a predetermined length.

Example 37 includes the subject matter of example 36, wherein a target portion from the target portions is to comprise the input string appended with padding bits to conform the target portion to the predetermined length.

Example 38 includes the subject matter of example 32, wherein the plurality of streams is to be generated by splitting, by the accelerator, the fixed-length data buffer into the plurality of streams, each stream comprising a split portion of an entry in the fixed-length data buffer.

Example 39 includes the subject matter of example 38, wherein an index from a stream is filtered in response to the split portion at that index in the stream matching a corresponding target portion from the input string.

Example 40 includes the subject matter of example 38, wherein indexes are to be aggregated by performing a bitwise AND operation.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

What is claimed is:

1. An apparatus, comprising:
an interface to a processor; and
accelerator circuitry to:
receive a data buffer from the processor, the data buffer to comprise a plurality of strings, the data buffer to be based on an input string;
generate a fixed-length data buffer based on the data buffer, respective ones of a plurality of entries of the fixed-length data buffer based on respective ones of the plurality of strings;
generate a plurality of streams, respective ones of the plurality of streams to comprise a portion of respective entries in the fixed-length data buffer;
receive, from the processor based on the input string, a plurality of target portions of the input string;
generate indexes of the plurality of streams based on respective target portions of the input string matching respective entries of the plurality of streams; and
transmit the indexes to the processor.

2. The apparatus of claim 1, wherein the fixed-length data buffer is to be generated based on a run length encoding operation of the accelerator circuitry.

3. The apparatus of claim 1, wherein the fixed-length data buffer is to be generated based on a splitting operation of the accelerator circuitry.

4. The apparatus of claim 1, wherein the fixed-length data buffer is to be generated based on an aggregation operation of the accelerator circuitry.

5. The apparatus of claim 1, wherein the fixed-length data buffer is to be generated based on a filtering operation of the accelerator circuitry.

6. The apparatus of claim 1, wherein an entry in the fixed-length data buffer is to comprise a corresponding string from the data buffer appended with padding bits to conform the entry to a predetermined length.

7. The apparatus of claim 6, wherein a target portion from the target portions is to comprise the input string appended with padding bits to conform the target portion to the predetermined length.

8. The apparatus of claim 1, wherein the plurality of streams are to be generated by splitting the fixed-length data buffer into the plurality of streams, each stream to comprise a split portion of an entry in the fixed-length data buffer.

9. The apparatus of claim 8, wherein the accelerator circuitry is to filter an index from a stream in response to the split portion at that index in the stream matching a corresponding target portion from the input string.

10. The apparatus of claim 8, wherein the accelerator circuitry is to aggregate the indexes based on a bitwise AND operation prior to transmitting the indexes to the processor.

11. A non-transitory computer-readable storage medium, the computer-readable storage medium including instructions that when executed by an accelerator device, cause the accelerator device to:
receive a data buffer from a processor, the data buffer to comprise a plurality of strings, the data buffer to be based on an input string;
generate a fixed-length data buffer based on the data buffer, respective ones of a plurality of entries of the fixed-length data buffer based on respective ones of the plurality of strings;
generate a plurality of streams, respective ones of the plurality of streams to comprise a portion of respective entries in the fixed-length data buffer;
receive, from the processor based on the input string, a plurality of target portions of the input string;
generate indexes of the plurality of streams based on respective target portions of the input string matching respective entries of the plurality of streams; and
transmit the indexes to the processor.

12. The non-transitory computer-readable storage medium of claim 11, wherein the fixed-length data buffer is to be generated based on a run length encoding operation of the accelerator.

13. The non-transitory computer-readable storage medium of claim 11, wherein the fixed-length data buffer is to be generated based on a splitting operation of the accelerator.

14. The non-transitory computer-readable storage medium of claim 11, wherein the fixed-length data buffer is to be generated based on an aggregation operation of the accelerator.

15. The non-transitory computer-readable storage medium of claim 11, wherein the fixed-length data buffer is to be generated based on a filtering operation of the accelerator.

16. A method, comprising:
receiving, by a processor, an input string to filter records in a dataset;
generating, by the processor, a plurality of target portions based on the input string; and
causing, by the processor, an accelerator device to filter the records in the dataset based on the target portions and by using a run length encoding feature of the accelerator device.

17. The method of claim 16, wherein the processor causes the accelerator device to filter the records using the run length encoding function to generate a fixed-length data buffer based on the dataset.

18. The method of claim 17, wherein the processor causes the accelerator device to filter the records based on the fixed-length data buffer by splitting the fixed-length data buffer into a predetermined number of data streams that are compared with the target portions.

19. The method of claim 18, wherein the processor causes the accelerator device to filter the records using an aggregation function to aggregate results of the comparing of the target portions with the data streams.

20. The method of claim 16, wherein the generating the plurality of target portions comprises generating an expanded input string and splitting the expanded input string into the plurality of target portions.
